(19) United States
(12) Patent Application Publication
(10) Pub. No.: US 2026/0176000 A1
(43) Pub. Date: Jun. 25, 2026

(54) MODULE-BASED AUTOMATICALLY SEPARABLE SPACE PROPULSION SYSTEM APPARATUS AND DESIGN METHOD THEREFOR

(71) Applicant: SHANGHAI INSTITUTE OF SPACE PROPULSION, Shanghai (CN)

(72) Inventors: Boyang WEI, Shanghai (CN); Jianhua TANG, Shanghai (CN); Shuaihua GU, Shanghai (CN); Xianyu ZENG, Shanghai (CN); Xiang LI, Shanghai (CN); Wentao YANG, Shanghai (CN); Daiyun WU, Shanghai (CN)

(21) Appl. No.: 19/431,977

(22) Filed: Dec. 23, 2025

(30) Foreign Application Priority Data
Dec. 25, 2024 (CN) 202411926430.6

(51) Int. Cl. B64G 1/40; B64G 1/64

(52) U.S. Cl. CPC B64G 1/4022; B64G 1/6459

(57) ABSTRACT

The present application provides a module-based automatically separable space propulsion system apparatus and a design method therefor. A storage and supply module has one end connected to an orbital maneuvering engine module via a first separation interface and another end connected to an attitude control engine module via a second separation interface. The storage and supply module provides propellants to the orbital maneuvering engine module and the attitude control engine module. The orbital maneuvering engine module provides thrust required for orbital maneuvering, and the attitude control engine module provides thrust required for attitude control. The first separation interface and the second separation interface are configured to allow separation among the storage and supply module, the orbital maneuvering engine module, and the attitude control engine module.

### CROSS REFERENCE TO RELATED APPLICATION

This patent application claims the benefit and priority of Chinese Patent Application No. 2024119264306, filed with the China National Intellectual Property Administration on Dec. 25, 2024, the disclosure of which is incorporated by reference herein in its entirety as part of the present application.

### TECHNICAL FIELD

The present disclosure relates to the technical field of space propulsion, and specifically, to a module-based automatically separable space propulsion system apparatus and a design method therefor.

### BACKGROUND

With the further development of lunar exploration programs, the establishment of lunar scientific research stations has become a goal of lunar exploration projects undertaken by various countries. The establishment of lunar scientific research stations requires transporting a large number of facilities and equipment from Earth to the Moon and completing assembly and construction on the lunar surface. Extraterrestrial landing vehicles capable of efficient transportation, rapid mobility on the lunar surface, and performing various lunar surface experiments will become one of the key research areas for China's future lunar exploration projects.

For extraterrestrial landing vehicles, propellants are consumables with substantial demand. The propulsion system often occupies a significant portion of the payload capacity and volume, and poses certain hazards due to the use of toxic propellants and high-pressure gases. Furthermore, after landing, extraterrestrial landing vehicles operate for extended periods on the lunar surface without needing to frequently travel between the lunar surface and near-lunar orbit, thus eliminating the need for the propulsion system functionality.

Designing the propulsion system in a separable configuration can not only significantly reduce the mass of the extraterrestrial landing vehicle, improving the mobility and reducing energy consumption, but also avoid the hazards posed by toxic propellants and high-pressure gases to the spacecraft and astronauts. Current separation schemes for space propulsion systems mostly involve the separation of the entire propulsion system.

Chinese patent CN112298617B discloses a main structure of an in-orbit separable satellite propulsion service module, including: a central load-bearing cylinder, an oxygen tank, two fuel tanks, two horizontal brackets, four side plates, an upper internal support plate, a lower internal support plate, a load-bearing cylinder adapter frame, and two or more connecting components. The lower end of the load-bearing cylinder adapter frame is detachably connected to the upper frame of the central load-bearing cylinder. The standard band interface at the upper end of the load-bearing cylinder adapter frame is detachably connected to an external payload module via a band. The oxygen tank, the upper internal support plate, and the lower internal support plate are all coaxially installed inside the central load-bearing cylinder. The two horizontal brackets are fixed to the outer circumferential surface of the central load-bearing cylinder. The two fuel tanks are respectively coaxially fixed within the corresponding rings of the horizontal brackets. Both sides of each horizontal bracket are integrally connected to the side wall of the central load-bearing cylinder and the upper and lower internal support plates via the side plates and the connecting components.

However, Chinese patent CN112298617B requires the addition of independent modules or additional components, imposing higher requirements on the spacecraft configuration. Moreover, there is currently no separable design method or apparatus applicable to the propulsion system modules of extraterrestrial landing vehicles.

### SUMMARY

Aiming at the deficiencies in the prior art, an objective of the present disclosure is to provide a module-based automatically separable space propulsion system apparatus and a design method therefor.

The present disclosure provides a module-based separable space propulsion system apparatus, including: a storage and supply module, an orbital maneuvering engine module, an attitude control engine module, a first separation interface, and a second separation interface; and
the storage and supply module has one end connected to the orbital maneuvering engine module via the first separation interface and another end connected to the attitude control engine module via the second separation interface; the storage and supply module supplies propellants to the orbital maneuvering engine module and the attitude control engine module, the orbital maneuvering engine module provides thrust required for orbital maneuvering, and the attitude control engine module provides thrust required for attitude control; and the first separation interface and the second separation interface are configured to allow separation among the storage and supply module, the orbital maneuvering engine module, and the attitude control engine module.

Preferably, a downstream side of the storage and supply module is connected to the first separation interface and the second separation interface via pipelines;
an upstream side of the orbital maneuvering engine module is connected to the first separation interface via a pipeline; and
an upstream side of the attitude control engine module is connected to the second separation interface via a pipeline.

Preferably, the first separation interface and the second separation interface each include a gas/liquid pipeline connection separation apparatus, an electrical connection separation apparatus, a mechanical structure connection unlocking apparatus, and a mechanical structure separation apparatus that are standardized.

Preferably, the gas/liquid pipeline connection separation apparatus is disposed at a pipeline connection position; and
the mechanical structure connection unlocking apparatus is a pneumatic unlocking apparatus, and the mechanical structure separation apparatus is a pneumatic separation apparatus, both of which can be actuated by gas supplied from an upstream gas pipeline to perform connection unlocking and separation functions of mechanical structures.

The electrical connection separation apparatus, the mechanical structure connection unlocking apparatus, and the mechanical structure separation apparatus are disposed between each of the storage and supply module, the orbital maneuvering engine module, and the attitude control engine module and an exterior of the spacecraft cabin.

Preferably, each of the storage and supply module, the orbital maneuvering engine module, and the attitude control engine module is connected to the gas/liquid pipeline connection separation apparatus via the pipeline; each circuit is connected to the electrical connection separation apparatus; and each mechanical structure is fixed to the mechanical structure connection unlocking apparatus.

Preferably, all apparatuses connected via gas/liquid pipelines on the first separation interface and the second separation interface are capable of achieving system-controlled, automatic unlocking or separation without assistance from external apparatuses;
any one or more of the storage and supply module, the orbital maneuvering engine module, and the attitude control engine module are capable of achieving pipeline separation and sealing with another module through separation and sealing actions of the gas/liquid pipeline connection separation apparatus on the first separation interface or the second separation interface;
any one or more of the storage and supply module, the orbital maneuvering engine module, and the attitude control engine module are capable of achieving unmanned automatic electrical separation through the electrical connection separation apparatus on the first separation interface or the second separation interface; and
any one or more of the storage and supply module, the orbital maneuvering engine module, and the attitude control engine module are capable of achieving ejection and separation of an entire structure of the module from a surface of a spacecraft cabin through the mechanical structure connection unlocking apparatus and the mechanical structure separation apparatus that are both pneumatically actuated on the first separation interface or the second separation interface.

The present disclosure provides a design method for the module-based separable space propulsion system apparatus, including following steps:
step S1: determining a configuration of a propulsion system and performing modularization, to divide components of the propulsion system into the storage and supply module, the orbital maneuvering engine module, and the attitude control engine module;
step S2: based on a modular design result, analyzing and determining connection pipelines between modules, and electrical connections and mechanical structure connections between the modules and a spacecraft, determining potential separation nodes, and obtaining corresponding separation schemes based on the potential separation nodes; and
step S3: designing and adding separation interfaces for each of the separation schemes, and determining an automatic separation process.

Preferably, the storage and supply module supplies propellants to downstream engines of the propulsion system and includes a gas cylinder, a storage tank, and a pressure reducing valve;
the orbital maneuvering engine module provides thrust required for orbital maneuvering and includes an orbital maneuvering engine;
the attitude control engine module provides thrust required for attitude control and includes an attitude control engine; and
other components are distributed in the storage and supply module, the orbital maneuvering engine module, and the attitude control engine module, with minimal use of the connection pipelines between the modules.

Preferably, the step S2 includes: determining pipeline separation points between the modules based on the connection pipelines between the modules of the propulsion system, where the orbital maneuvering engine module and the storage and supply module are connected via a liquid pipeline; the attitude control engine module and the storage and supply module are connected via a liquid pipeline, all the modules are arranged on a surface of the spacecraft, and components within each module are fixed to a same separation plane; designing connection and fixation points and electrical interfaces for each separation plane; and adding gas-driven pipelines required for separation.

Preferably, each of the separation interfaces in the step S3 includes a gas/liquid pipeline connection separation portion, an electrical connection separation portion, a mechanical structure connection unlocking portion, and a mechanical structure separation portion; and the determining the automatic separation process includes determining a separation order of the modules and a separation order of the separation interfaces, where priority is given to separation of the gas/liquid pipeline connection separation portion, followed by unlocking of the mechanical structure connection unlocking portion, and finally separation of the electrical connection separation portion and separation of the mechanical structure separation portion.

Compared with the prior art, the present disclosure has the following beneficial effects.
1. The present disclosure enables separation of the propulsion system, allowing removal of part of the propulsion system. Thereby, the overall volume and mass of extraterrestrial landing vehicles such as lunar or Mars landers are reduced, improving the operational efficiency of the propulsion system, and lowering energy consumption.
2. The present disclosure eliminates redundant structures such as gas cylinders, storage tanks, and engines, thereby reducing the potential risks posed by high-pressure gases and toxic propellants to the spacecraft and astronauts. This enhances operational safety and reliability.
3. The separation interfaces and separation program proposed in the present disclosure enable the remote-controlled separation of modules of the propulsion system without requiring assistance from external personnel or robotic arms. This greatly expands the application scope.
4. The present disclosure employs the mechanical structure connection unlocking apparatus and the mechanical structure separation apparatus that are pneumatically actuated, which utilize the gas source from the upstream gas pipeline of the propulsion system. This reduces energy consumption and increases separation reliability.

### BRIEF DESCRIPTION OF THE DRAWINGS

Other features, objectives, and advantages of the present disclosure will become more apparent by reading the detailed description of non-limiting examples with reference to the following accompanying drawings.

FIG. 1 is a schematic diagram of a module-based separable space propulsion system configuration and a method therefor according to the present disclosure;

FIG. 2 is a schematic diagram of a module-based separable space propulsion system apparatus according to the present disclosure;

FIG. 3 is a schematic structural diagram of a gas/liquid pipeline connection separation apparatus on a separation interface according to the present disclosure;

FIG. 4 is a schematic diagram of installation locations of an electrical connection separation apparatus, mechanical structure connection unlocking apparatuses, and mechanical structure separation apparatuses on separation interfaces according to the present disclosure; and

FIG. 5 is an overall schematic diagram of a modular system and separation interfaces according to the present disclosure.

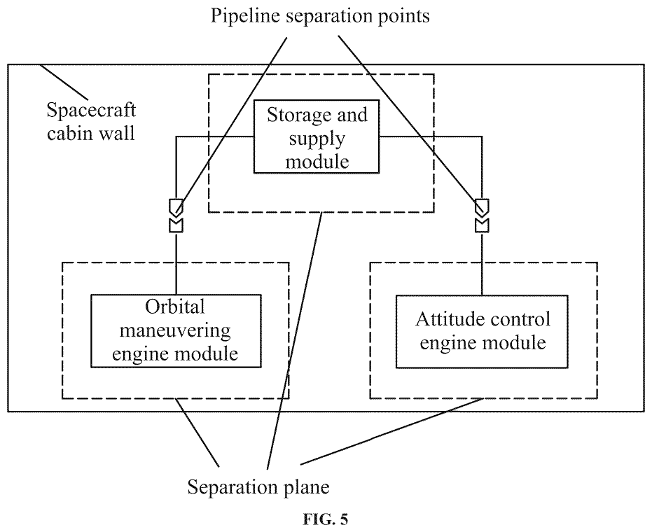

### DETAILED DESCRIPTION OF THE EMBODIMENTS

The disclosure will be described in detail below in combination with examples. The following examples will help those skilled in the art to further understand the present disclosure, but do not limit the present disclosure in any way. It should be noted that several variations and improvements can also be made by a person of ordinary skill in the art without departing from the conception of the present disclosure. These all fall within the protection scope of the present disclosure.

In recent years, with the further development of lunar exploration programs, China has proposed the concept of a manned lunar surface laboratory with autonomous landing capabilities. The propulsion system is a key component to the landing function, but it is no longer needed after landing. The propulsion system not only occupies a significant portion of the payload and volume of the lunar facility, but also poses a certain level of danger due to the use of toxic propellants and high-pressure gases. Separating the propulsion system after the lunar facility has landed not only greatly reduces the mass of the lunar facility, but also avoids the risks associated with toxic propellants and high-pressure gases.

### Embodiment 1

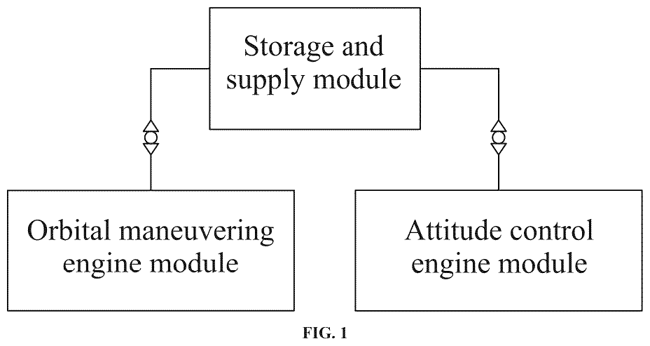

The present disclosure provides a module-based separable space propulsion system apparatus. As shown in FIG. 1, the apparatus includes: a storage and supply module, an orbital maneuvering engine module, an attitude control engine module, a first separation interface, and a second separation interface. The storage and supply module has one end connected to the orbital maneuvering engine module via the first separation interface, and another end connected to the attitude control engine module via the second separation interface. A downstream side of the storage and supply module is connected to the first separation interface and the second separation interface via pipelines. An upstream side of the orbital maneuvering engine module is connected to the first separation interface via a pipeline. An upstream side of the attitude control engine module is connected to the second separation interface via a pipeline.

The first separation interface and the second separation interface each include a gas/liquid pipeline connection separation apparatus, an electrical connection separation apparatus, a mechanical structure connection unlocking apparatus, and a mechanical structure separation apparatus that are standardized. The gas/liquid pipeline connection separation apparatus is disposed at a pipeline connection position. The mechanical structure connection unlocking apparatus is a pneumatic unlocking apparatus, and the mechanical structure separation apparatus is a pneumatic separation apparatus. The electrical connection separation apparatus, and the mechanical structure connection unlocking apparatus and the mechanical structure separation apparatus that are both pneumatically actuated are disposed on separation interfaces between each of the storage and supply module, the orbital maneuvering engine module, and the attitude control engine module and an exterior of the spacecraft cabin. Through the automatic separation process design, the system-controlled, automatic unlocking or separation without assistance from external apparatuses can be achieved. Each of the storage and supply module, the orbital maneuvering engine module, and the attitude control engine module is connected to the gas/liquid pipeline connection separation apparatus via a pipeline. Each circuit is connected to the electrical connection separation apparatus on the separation interface. Each mechanical structure is fixed to the mechanical structure connection unlocking apparatus on the separation interface.

All apparatuses connected via gas/liquid pipelines on the separation interfaces are capable of achieving system-controlled, automatic unlocking or separation without assistance from external apparatuses. Any one or more of the storage and supply module, the orbital maneuvering engine module, and the attitude control engine module are capable of achieving pipeline separation and sealing with another module through separation and sealing actions of the gas/liquid pipeline connection separation apparatus on the separation interface. Any one or more of the storage and supply module, the orbital maneuvering engine module, and the attitude control engine module are capable of achieving unmanned automatic electrical separation through the electrical connection separation apparatus on the separation interface. Any one or more of the storage and supply module, the orbital maneuvering engine module, and the attitude control engine module are capable of achieving ejection and separation of an entire structure of the module from a surface of the spacecraft cabin through the mechanical structure connection unlocking apparatus and the mechanical structure separation apparatus that are both pneumatically actuated on the separation interface.

### Embodiment 2

The present disclosure provides a design method for a module-based separable space propulsion system apparatus, including following steps:

In step S1, a configuration of a propulsion system is determined and modular design is performed, to minimize the number of connection nodes between modules. The step S1 specifically includes dividing components of the propulsion system into the storage and supply module, the orbital maneuvering engine module, and the attitude control engine module. The storage and supply module supplies propellants to downstream engines of the propulsion system and includes a gas cylinder, a storage tank, and a pressure reducing valve. The orbital maneuvering engine module provides thrust required for orbital maneuvering and includes an orbital maneuvering engine. The attitude control engine module provides thrust required for attitude control and includes an attitude control engine. Other components are distributed in the three modules, with minimal use of connection pipelines between the modules.

In step S2, based on a modular design result, connection pipelines between the modules, and electrical connections and mechanical structure connections between the modules and a spacecraft are analyzed and determined, potential separation nodes are determined, and corresponding separation schemes are obtained based on the potential separation nodes. The step S2 includes: determining pipeline separation points between the modules based on the connection pipelines between the modules of the propulsion system. The orbital maneuvering engine module and the storage and supply module are connected via a liquid pipeline; and the attitude control engine module and the storage and supply module are connected via a liquid pipeline. All the modules are arranged on a surface of the spacecraft, and components within each module are fixed to a same separation plane. Connection and fixation points and electrical interfaces for each separation plane are designed; and gas-driven pipelines required for separation are added.

In step S3, separation interfaces are designed and added for each separation scheme, and an automatic separation process is determined. The separation interface in the step S3 includes a gas/liquid pipeline connection separation portion, an electrical connection separation portion, a mechanical structure connection unlocking portion, and a mechanical structure separation portion, and gas supply pipelines required for the mechanical structure connection unlocking apparatus and the mechanical structure separation apparatus are added on the storage and supply module. Specifically, for the pipeline separation points between the modules, the gas/liquid pipeline connection separation portions of the separation interfaces are arranged, enabling each module to automatically disconnect its pipeline from another module. For the connection and fixation points on separation planes of the storage and supply module, the orbital maneuvering engine module, and the attitude control engine module, the mechanical structure connection unlocking portions and the mechanical structure separation portions of the separation interfaces are arranged, enabling each module to achieve mechanical structure unlocking and ejection separation driven by gases in the gas pipelines. For the electrical connection points on the separation planes of the storage and supply module, the orbital maneuvering engine module, and the attitude control engine module, the electrical connection separation portions of the separation interface are arranged, enabling each module to achieve automatic electrical separation.

The determining the automatic separation sequence includes determining a separation order of the modules and a separation order of the separation interfaces. Priority is given to separation of the gas/liquid pipeline connection separation portion, followed by unlocking of the mechanical structure connection unlocking portion, and finally separation of the electrical connection separation portion and separation of the mechanical structure separation portion.

The present disclosure enables separation of the unused propulsion system from extraterrestrial landing vehicles such as lunar or Mars landers, achieves automatic separation of the propulsion system, ensures the safety of the extraterrestrial landing vehicles, and improves the mobility performance. The present disclosure achieves modular ejection and separation of the propulsion system, allowing removal of part of the propulsion system, thereby reducing the overall volume and mass of the spacecraft and improving the operational efficiency of the propulsion system. The removal of redundant structures reduces the potential risks associated with high-pressure gases and toxic propellants, further enhancing operational safety. The proposed separation interfaces and separation program enable the remote-controlled separation of modules of the propulsion system without requiring assistance from external personnel or robotic arms. This greatly expands the application scope.

### Embodiment 3

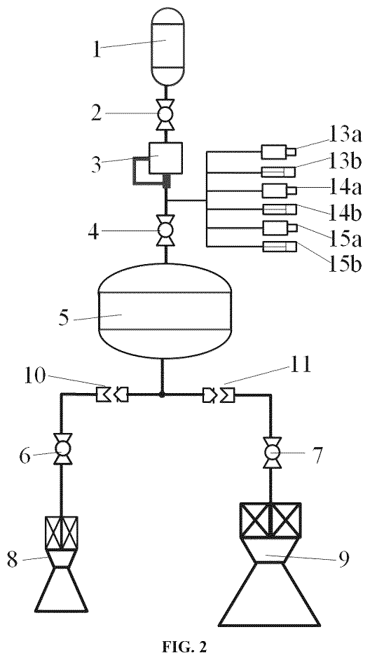

This embodiment is a preferred implementation of Embodiment 1. This embodiment provides a module-based separable space propulsion system apparatus. As shown in FIG. 2, the apparatus includes a gas cylinder 1, a latching valve 2, a pressure reducing valve 3, a latching valve 4, a storage tank 5, a gas/liquid pipeline connection separation apparatus 10 on a separation interface, a gas/liquid pipeline connection separation apparatus 11 on a separation interface, a latching valve 6, a latching valve 7, an attitude control engine 8, and an orbital maneuvering engine 9. Furthermore, as shown in FIG. 2, the separation interface of the system apparatus includes: a mechanical structure connection unlocking apparatus 13a of a storage and supply module, a mechanical structure separation apparatus 13b of the storage and supply module, an electrical connection separation apparatus of the storage and supply module, a mechanical structure connection unlocking apparatus 14a of an orbital maneuvering engine module, a mechanical structure separation apparatus 14b of the orbital maneuvering engine module, an electrical connection separation apparatus of the orbital maneuvering engine module, a mechanical structure connection unlocking apparatus 15a of an attitude control engine module, a mechanical structure separation apparatus 15b of the attitude control engine module, and an electrical connection separation apparatus of the attitude control engine module.

### Embodiment 4

This embodiment is a design method for the module-based separable space propulsion system apparatus based on Embodiment 3 and is a preferred implementation of Embodiment 2.

In this embodiment, specifically, the design method for the module-based separable space propulsion system apparatus includes following steps:

In step 1, a configuration of a propulsion system is determined and modular design is performed, to minimize the number of connection nodes between modules. First, the configuration of the propulsion system is determined. The basic propulsion system in this example is consistent with FIG. 1, except that it does not include the gas/liquid pipeline connection separation apparatus 10 on the separation interface and the gas/liquid pipeline connection separation apparatus 11 on the separation interface. The propulsion system includes a gas cylinder 1, a latching valve 2, a pressure reducing valve 3, a latching valve 4, a storage tank 5, a latching valve 6, a latching valve 7, an attitude control engine 8, and an orbital maneuvering engine 9. The gas cylinder 1 is connected to the storage tank 5 via a gas pipeline, sequentially through the latching valve 2, the pressure reducing valve 3, and the latching valve 4. The upstream of the storage tank 5 is connected to the latching valve 4 via a gas pipeline, and the downstream is connected in parallel to the latching valve 6 and latching valve 7 via liquid pipelines. The downstream of the latching valve 6 is connected to the attitude control engine via a liquid pipeline, and the downstream of the latching valve 7 is connected to the orbital maneuvering engine via a liquid pipeline.

The components of the propulsion system are divided into the storage and supply module, the orbital maneuvering engine module, and the attitude control engine module. The modular design should follow the following design principles: integrating most valves and pipelines into the modules, using as few connection pipelines as possible between the modules, and minimizing the number of separation nodes to help reduce the mass of separation apparatuses and improve separation reliability. On this basis, a single module integrates as many components as possible, with functional cohesion, aiming to realize more internal functions within one module and minimize external interfaces such as structure, gas/liquid, and electrical interfaces. The storage and supply module includes the gas cylinder 1, the latching valve 2, the pressure reducing valve 3, the latching valve 4, and the storage tank 5. The orbital maneuvering engine module includes the latching valve 7 and the orbital maneuvering engine 9. The attitude control engine module includes the latching valve 6 and the attitude control engine 8. The storage and supply module is connected via liquid pipelines to the orbital maneuvering engine module and the attitude control engine module. The modular propulsion system obtained is shown in FIG. 1.

In step 2, based on a modular design result, connection pipelines between the modules, and electrical connections and mechanical structure connections between the modules and the spacecraft are analyzed and determined, potential separation nodes are determined, and potential separation schemes are obtained based on the potential separation nodes. The connection pipelines between the modules of the propulsion system include the liquid pipeline between the storage and supply module and the orbital maneuvering engine module, and the liquid pipeline between the storage and supply module and the attitude control engine module. Accordingly, it is determined that the separation points for the pipelines between the modules are located within the two liquid pipelines. The configuration of inter-module and intra-module pipelines should be carefully considered to avoid mutual interference between the pipelines during separation. All the modules are arranged on the surface of the spacecraft, and components within each module are fixed to a same separation plane, to achieve overall separation of the module. The mechanical and thermodynamic analysis is carried out on each separation plane and the surface of the spacecraft. The connection/fixation points and corresponding separation points for each separation plane are designed, and a gas-driven pipeline is added in the storage and supply module. Electrical interfaces with the spacecraft are configured on the separation planes according to the electrical interface requirements of the modules.

In this embodiment, a separation scheme involving the storage and supply module, the orbital maneuvering engine module, and the attitude control engine module needs to be considered, for separate separation of the three modules. The aforementioned separation plane is a rigid thin plate structure. Components of each module are securely fixed to the separation plane and capable of being ejected without deformation.

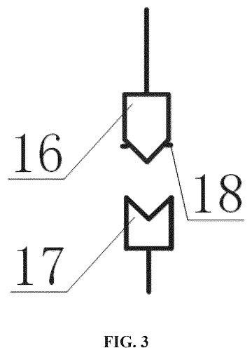

In step 3, separation interfaces are designed and added for each separation scheme, and a separation process is determined. In this embodiment, the separation interface includes a gas/liquid pipeline connection separation apparatus, an electrical connection separation apparatus, a mechanical structure connection unlocking apparatus, and a mechanical structure separation apparatus. The mechanical structure connection unlocking apparatus adopts a plurality of pneumatic separation nuts, and the mechanical structure separation apparatus adopts a plurality of pneumatic push rods. The gas/liquid pipeline connection separation apparatus adopts a plurality of liquid pipeline floating disconnectors. The electrical connection separation apparatus adopts a plurality of electrical circuit floating disconnectors. A schematic structural diagram of the gas/liquid pipeline connection separation apparatus on the separation interface is shown in FIG. 3.

The liquid pipeline floating disconnectors on the separation interfaces specifically correspond to the gas/liquid pipeline connection separation apparatus 10 and the gas/liquid pipeline connection separation apparatus 11 on the separation interfaces, each including an active terminal 16 of the liquid pipeline floating disconnector, a passive terminal 17 of the liquid pipeline floating disconnector, and a sealing apparatus 18. Before propulsion system separation, the active terminal 16 and the passive terminal 17 of the liquid pipeline floating disconnector are connected, achieving liquid pipeline sealing via the sealing apparatus 18.

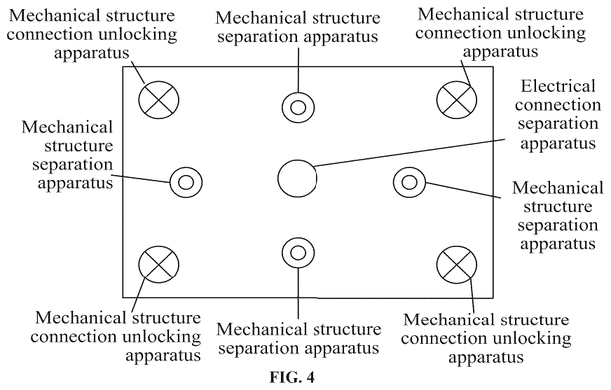

FIG. 4 is a schematic diagram of installation locations of the electrical connection separation apparatus, the mechanical structure connection unlocking apparatuses, and the mechanical structure separation apparatuses on the separation interface. The gas/liquid pipeline connection separation apparatus and the electrical connection separation apparatus adopt active-passive structures, and an active control terminal and a passive apparatus part are located at two sides of the separation point respectively. The mechanical structure connection unlocking apparatus and the mechanical structure separation apparatus employ active-passive structures. An active control terminal is located on the storage and supply module and is driven by the low-pressure gas source from the downstream of the pressure reducing valve: Gas enters a gas chamber of the mechanical structure connection unlocking apparatus, driving the separation nut structure to split and unlock; and then gas enters a gas chamber of the mechanical structure separation apparatus, pushing the piston rod to move and achieve ejection separation.

For the separation point in the liquid pipeline between the storage and supply module and the orbital maneuvering engine module, and for the separation point in the liquid pipeline between the storage and supply module and the attitude control engine module, the aforementioned pipeline connection separation apparatus 10a and pipeline connection separation apparatus 11a on the separation interface are arranged.

Between the separation plane of each module and the spacecraft cabin, for the connection and fixation points and corresponding separation points on the separation plane of the storage and supply module, the mechanical structure connection unlocking apparatus 13a and the mechanical structure separation apparatus 13b of the storage and supply module are arranged on the separation interface. For the connection and fixation points and corresponding separation points on the separation plane of the orbital maneuvering engine module, the mechanical structure connection unlocking apparatus 14a and the mechanical structure separation apparatus 14b of the orbital maneuvering engine module are arranged. For the connection and fixation points and corresponding separation points on the separation plane of the attitude control engine module, the mechanical structure connection unlocking apparatus 15a and the mechanical structure separation apparatus 15b of the attitude control engine module are arranged. All mechanical structure separation apparatuses and mechanical structure connection unlocking apparatuses are connected via drive gas circuits to the gas pipeline between the pressure reducing valve 3 and the latching valve 4 in the storage and supply module.

Between the separation plane of each module and the spacecraft cabin, for the electrical interface between the separation plane of the storage and supply module and the spacecraft, the electrical connection separation apparatus of the storage and supply module is arranged. For the electrical interface between the separation plane of the orbital maneuvering engine module and the spacecraft, the electrical connection separation apparatus of the orbital maneuvering engine module is arranged. For the electrical interface between the attitude control engine module and the spacecraft, the electrical connection separation apparatus of the attitude control engine module is arranged.

Based on the determined separation apparatuses, the separation program is designed. Propulsion system separation involves three aspects: structure, gas/liquid pipeline, and electrical connection separation. Each has different requirements for control and timing. Structure separation involves the control of pyrotechnic apparatuses, the gas/liquid pipeline separation involves the safety of propellants and high-pressure gases, and electrical connection separation is the key to achieving separation control. Only with proper matching of the separation apparatuses for these three aspects can the separation process be completed safely and successfully. For the overall separation program of the propulsion system, an automatic separation scheme is adopted.

In the automatic separation mode, the separation process is executed according to a program: First, the unlocking and separation of pipelines of the propulsion system are performed, then module structures of the propulsion system are unlocked, and finally the unlocked modules of the propulsion system are separated from the spacecraft and retreat to a safe distance. The entire process is unmanned. During separation, follow the principle of unlocking before separation. For gas/liquid pipeline separation, when different unlocking schemes are involved, motor-driven unlocking and separation are prioritized. Separation methods with greater impact, such as pneumatic separation nuts, are implemented as the final step. In the mechanical structure unlocking and separation phase, a symmetric ejection separation scheme should be adopted to reduce the impact of impulse or uneven mass distribution on the stability and safety of the lunar surface facility during separation.

In this embodiment, the separation program proceeds according to the following steps:
1) First, the pipeline connection separation apparatus 10a and the pipeline connection separation apparatus 11a on the separation interfaces are controlled to perform liquid pipeline separation and sealing.
2) After confirming the successful separation and sealing of the pipelines to be separated, the mechanical structure connection unlocking apparatus 13a of the storage and supply module, the mechanical structure connection unlocking apparatus 14a of the orbital maneuvering engine module, and the mechanical structure connection unlocking apparatus 15a of the attitude control engine module are controlled to unlock the mechanical structure connections between the separation planes of the storage and supply module, the orbital maneuvering engine module, and the attitude control engine module, and the spacecraft surface.
3) After confirming the successful unlocking of all the mechanical structure connection unlocking apparatuses, the mechanical structure separation apparatus 13b of the storage and supply module, the mechanical structure separation apparatus 14b of the orbital maneuvering engine module, and the mechanical structure separation apparatus 15b of the attitude control engine module are controlled to perform mechanical structure separation. The push rod action causes the separation planes of the storage and supply module, the orbital maneuvering engine module, and the attitude control engine module to separate synchronously from the spacecraft surface. Simultaneously, signals are sent to control the electrical connection separation apparatus of the storage and supply module, the electrical connection separation apparatus of the orbital maneuvering engine module, and the electrical connection separation apparatus of the attitude control engine module to synchronously separate the electrical interfaces between the spacecraft surface and the separation planes of the storage and supply module, the orbital maneuvering engine module, and the attitude control engine module.

Accordingly, after applying the described design method for a module-based separable space propulsion system to the initial propulsion system configuration of this embodiment, the module-based separable space propulsion system apparatus shown in FIG. 1 is formed. The gas/liquid pipeline connection separation apparatus 10 of the separation interface and the gas/liquid pipeline connection separation apparatus 11 of the separation interface are added.

The upstream of the gas/liquid pipeline connection separation apparatus 10 is connected via a liquid pipeline to the storage tank 5 and the gas/liquid pipeline connection separation apparatus 11 of the separation interface, and the downstream is connected via a liquid pipeline to the attitude control engine 8. The upstream of the gas/liquid pipeline connection separation apparatus 11 is connected via a liquid pipeline to the storage tank 5 and the gas/liquid pipeline connection separation apparatus 10 of the separation interface, and the downstream is connected via a liquid pipeline to the orbital maneuvering engine 9.

In the description of the present application, it needs to be understood that the orientation or positional relationships indicated by terms, such as “up”, “down”, “front”, “rear”, “left”, “right”, “vertical”, “horizontal”, “top”, “bottom”, “inside”, and “outside”, are based on the orientation or positional relationship shown in the accompanying drawings, are merely for facilitating the description of the present application and simplifying the description, rather than indicating or implying that an apparatus or element referred to must have a particular orientation or be constructed and operated in a particular orientation, and therefore shall not be interpreted as limiting the present application.

The specific embodiments of the present disclosure are described above. It should be understood that the present disclosure is not limited to the above specific implementations, and a person skilled in the art can make various variations or modifications within the scope of the claims without affecting the essence of the present disclosure. The examples in the present application and the characteristics in the examples can be combined mutually in the case of no conflict.

What is claimed is:

1. A module-based separable space propulsion system apparatus, comprising: a storage and supply module, an orbital maneuvering engine module, an attitude control engine module, a first separation interface, and a second separation interface, wherein
the storage and supply module has one end connected to the orbital maneuvering engine module via the first separation interface and another end connected to the attitude control engine module via the second separation interface; the storage and supply module supplies propellants to the orbital maneuvering engine module and the attitude control engine module, the orbital maneuvering engine module provides thrust required for orbital maneuvering, and the attitude control engine module provides thrust required for attitude control; and the first separation interface and the second separation interface are configured to allow separation among the storage and supply module, the orbital maneuvering engine module, and the attitude control engine module.

2. The module-based separable space propulsion system apparatus according to claim 1, wherein a downstream side of the storage and supply module is connected to the first separation interface and the second separation interface via pipelines;
an upstream side of the orbital maneuvering engine module is connected to the first separation interface via a pipeline; and
an upstream side of the attitude control engine module is connected to the second separation interface via a pipeline.

3. The module-based separable space propulsion system apparatus according to claim 1, wherein the first separation interface and the second separation interface each comprise a gas/liquid pipeline connection separation apparatus, an electrical connection separation apparatus, a mechanical structure connection unlocking apparatus, and a mechanical structure separation apparatus that are standardized.

4. The module-based separable space propulsion system apparatus according to claim 3, wherein the gas/liquid pipeline connection separation apparatus is disposed at a pipeline connection position;
the mechanical structure connection unlocking apparatus is a pneumatic unlocking apparatus, and the mechanical structure separation apparatus is a pneumatic separation apparatus; and
the electrical connection separation apparatus, and the mechanical structure connection unlocking apparatus and the mechanical structure separation apparatus that are both pneumatically actuated are disposed between each of the storage and supply module, the orbital maneuvering engine module, and the attitude control engine module and an exterior of the spacecraft cabin.

5. The module-based separable space propulsion system apparatus according to claim 4, wherein each of the storage and supply module, the orbital maneuvering engine module, and the attitude control engine module is connected to the gas/liquid pipeline connection separation apparatus via the pipeline; each circuit is connected to the electrical connection separation apparatus; and each mechanical structure is fixed to the mechanical structure connection unlocking apparatus.

6. The module-based separable space propulsion system apparatus according to claim 1, wherein all apparatuses connected via gas/liquid pipelines on the first separation interface and the second separation interface are capable of achieving system-controlled, automatic unlocking or separation without assistance from external apparatuses;
any one or more of the storage and supply module, the orbital maneuvering engine module, and the attitude control engine module are capable of achieving pipeline separation and sealing with another module through separation and sealing actions of the gas/liquid pipeline connection separation apparatus on the first separation interface or the second separation interface;
any one or more of the storage and supply module, the orbital maneuvering engine module, and the attitude control engine module are capable of achieving unmanned automatic electrical separation through the electrical connection separation apparatus on the first separation interface or the second separation interface; and
any one or more of the storage and supply module, the orbital maneuvering engine module, and the attitude control engine module are capable of achieving ejection and separation of an entire structure of the module from a surface of a spacecraft cabin through the mechanical structure connection unlocking apparatus and the mechanical structure separation apparatus that are both pneumatically actuated on the first separation interface or the second separation interface.

7. A design method for the module-based separable space propulsion system apparatus according to claim 1, comprising following steps:
step S1: determining a configuration of a propulsion system and performing modularization, to divide components of the propulsion system into the storage and supply module, the orbital maneuvering engine module, and the attitude control engine module;
step S2: based on a modular design result, analyzing and determining connection pipelines between modules, and electrical connections and mechanical structure connections between the modules and a spacecraft, determining potential separation nodes, and obtaining corresponding separation schemes based on the potential separation nodes; and
step S3: designing and adding separation interfaces for each of the separation schemes, and determining an automatic separation process.

8. The design method for the module-based separable space propulsion system apparatus according to claim 7, wherein the storage and supply module supplies propellants to downstream engines of the propulsion system and comprises a gas cylinder, a storage tank, and a pressure reducing valve;
the orbital maneuvering engine module provides thrust required for orbital maneuvering and comprises an orbital maneuvering engine;
the attitude control engine module provides thrust required for attitude control and comprises an attitude control engine; and
other components are distributed in the storage and supply module, the orbital maneuvering engine module, and the attitude control engine module, with minimal use of the connection pipelines between the modules.

9. The design method for the module-based separable space propulsion system apparatus according to claim 7, wherein the step S2 comprises: determining pipeline separation points between the modules based on the connection pipelines between the modules of the propulsion system, wherein the orbital maneuvering engine module and the storage and supply module are connected via a liquid pipeline; the attitude control engine module and the storage and supply module are connected via a liquid pipeline, all the modules are arranged on a surface of the spacecraft, and components within each module are fixed to a same separation plane; designing connection and fixation points and electrical interfaces for each separation plane; and adding gas-driven pipelines required for separation.

10. The design method for the module-based separable space propulsion system apparatus according to claim 7, wherein each of the separation interfaces in the step S3 comprises a gas/liquid pipeline connection separation portion, an electrical connection separation portion, a mechanical structure connection unlocking portion, and a mechanical structure separation portion, and gas supply pipelines required for the mechanical structure connection unlocking apparatus and the mechanical structure separation apparatus are added on the storage and supply module; and
the determining the automatic separation process comprises determining a separation order of the modules and a separation order of the separation interfaces, wherein priority is given to separation of the gas/liquid pipeline connection separation portion, followed by unlocking of the mechanical structure connection unlocking portion, and finally separation of the electrical connection separation portion and separation of the mechanical structure separation portion.

11. The design method for the module-based separable space propulsion system apparatus according to claim 7, wherein a downstream side of the storage and supply module is connected to the first separation interface and the second separation interface via pipelines;
an upstream side of the orbital maneuvering engine module is connected to the first separation interface via a pipeline; and
an upstream side of the attitude control engine module is connected to the second separation interface via a pipeline.

12. The design method for the module-based separable space propulsion system apparatus according to claim 7, wherein the first separation interface and the second separation interface each comprise a gas/liquid pipeline connection separation apparatus, an electrical connection separation apparatus, a mechanical structure connection unlocking apparatus, and a mechanical structure separation apparatus that are standardized.

13. The design method for the module-based separable space propulsion system apparatus according to claim 12, wherein the gas/liquid pipeline connection separation apparatus is disposed at a pipeline connection position;
the mechanical structure connection unlocking apparatus is a pneumatic unlocking apparatus, and the mechanical structure separation apparatus is a pneumatic separation apparatus; and
the electrical connection separation apparatus, and the mechanical structure connection unlocking apparatus and the mechanical structure separation apparatus that are both pneumatically actuated are disposed between each of the storage and supply module, the orbital maneuvering engine module, and the attitude control engine module and an exterior of the spacecraft cabin.

14. The design method for the module-based separable space propulsion system apparatus according to claim 13, wherein each of the storage and supply module, the orbital maneuvering engine module, and the attitude control engine module is connected to the gas/liquid pipeline connection separation apparatus via the pipeline; each circuit is connected to the electrical connection separation apparatus; and each mechanical structure is fixed to the mechanical structure connection unlocking apparatus.

15. The design method for the module-based separable space propulsion system apparatus according to claim 7, wherein all apparatuses connected via gas/liquid pipelines on the first separation interface and the second separation interface are capable of achieving system-controlled, automatic unlocking or separation without assistance from external apparatuses;
any one or more of the storage and supply module, the orbital maneuvering engine module, and the attitude control engine module are capable of achieving pipeline separation and sealing with another module through separation and sealing actions of the gas/liquid pipeline connection separation apparatus on the first separation interface or the second separation interface;
any one or more of the storage and supply module, the orbital maneuvering engine module, and the attitude control engine module are capable of achieving unmanned automatic electrical separation through the electrical connection separation apparatus on the first separation interface or the second separation interface; and
any one or more of the storage and supply module, the orbital maneuvering engine module, and the attitude control engine module are capable of achieving ejection and separation of an entire structure of the module from a surface of a spacecraft cabin through the mechanical structure connection unlocking apparatus and the mechanical structure separation apparatus that are both pneumatically actuated on the first separation interface or the second separation interface.
